(19) United States
(12) Patent Application Publication
(10) Pub. No.: US 2006/0003750 A1
(43) Pub. Date: Jan. 5, 2006

(54) Automatic control of portable communication device behavior based on communication acceptance/rejection profile

(76) Inventors: Sumant Ranganathan, Sunnyvale, CA (US); Pieter Vorenkamp, Laguna Niguel, CA (US); Neil Y. Kim, Laguna Niguel, CA (US); Chun-ying Chen, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/166,762

(22) Filed: Jun. 24, 2005

Related U.S. Application Data
(60) Provisional application No. 60/585,289, filed on Jul. 1, 2004.

(51) Int. Cl. H04M 3/00; H04Q 7/20

(52) U.S. Cl. 455/414.1; 455/418

(57) ABSTRACT

A system and method for automatically controlling operation of a portable communication device based on a communication acceptance/rejection profile. Various aspects of the present invention may comprise receiving communication acceptance profile information. An interface module of a portable communication device may, for example, receive such information. Information describing a pending communication may be received. A receiver module of a portable communication device may, for example, receive such information. The communication acceptance profile information and the information describing the pending communication may be analyzed to determine whether to accept the pending communication. A communication acceptance determination module may, for example, perform such analysis. If it is determined that the communication should be accepted, then the communication may be received. A receiver module may perform such receiving. If it is determined that the communication should not be accepted, then the communication might not be received.

### CROSS-REFERENCE TO RELATED APPLICATIONS/INCORPORATION BY REFERENCE

This patent application is related to and claims priority from provisional patent application Ser. No. 60/585,289, filed Jul. 1, 2004, and entitled “AUTOMATIC CONTROL OF PORTABLE COMMUNICATION DEVICE BEHAVIOR BASED ON COMMUNICATION ACCEPTANCE/REJECTION PROFILE,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Communication networks are often burdened communicating unwanted messages to recipients. Unwanted communications waste finite communication resources, degrading network performance and increasing network cost.

Users of portable communication systems may receive unwanted communications. Such communications waste communication bandwidth and cause the portable communication systems to waste their often finite supplies of energy. Such unwanted communications also often cause unwanted interruptions for the user.

Additionally, users of portable communication systems may utilize the systems differently at different points throughout the day, week, etc. For example, a user may utilize a cellular phone for business or personal or emergency use in the office or during work hours, use the cellular phone for personal or emergency use during non-working hours, and use the cellular phone only for emergency use during sleeping hours.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for automatically controlling operation of a portable communication device based on a communication acceptance/rejection profile, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 illustrates an exemplary method for automatically controlling operation of a portable communication device based on a communication acceptance/rejection profile, in accordance with various aspects of the present invention.

FIG. 2 illustrates an exemplary method for automatically controlling operation of a portable communication device based on a communication acceptance/rejection profile, in accordance with various aspects of the present invention.

FIG. 3 shows a block diagram of an exemplary communication system implementing automatic control of portable communication device operation based on a communication acceptance/rejection profile, in accordance with various aspects of the present invention.

FIG. 4 shows a block diagram of an exemplary communication system implementing automatic control of portable communication device operation based on a communication acceptance/rejection profile, in accordance with various aspects of the present invention.

### DETAILED DESCRIPTION OF THE INVENTION

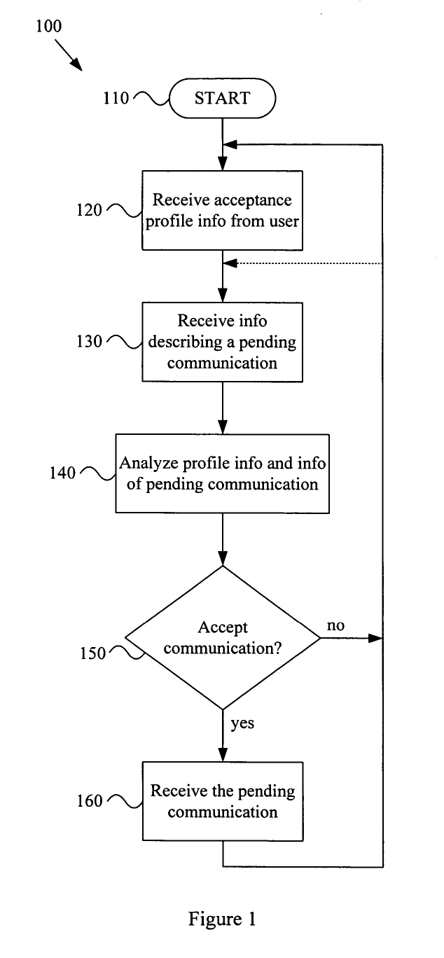

FIG. 1 illustrates an exemplary method 100 for automatically controlling operation of a portable communication device based on a communication acceptance/rejection profile, in accordance with various aspects of the present invention. The portable communication device may comprise characteristics of any of a variety of portable communication devices. For example and without limitation, the portable communication device may comprise a cellular phone. Also for example, the portable communication device may comprise a portable computer, electronic email device, pager, etc. Accordingly, the scope of various aspects of the present invention should not be limited by characteristics of a particular type of portable communication device.

The exemplary method 100 may start at step 110. The exemplary method 100, and other exemplary methods and functionality discussed herein, may begin executing for any of a variety of reasons. For example and without limitation, the exemplary method 100 may begin in response to an explicit user request. Also for example, the exemplary method 100 may begin in response to the arrival of communication acceptance profile information at a system implementing the method 100. Further for example, portions of the exemplary method 100 may begin in response to the arrival of communication information at a portable communication device or a device providing a network communication link to a portable communication device. Accordingly, the scope of various aspects of the present invention should not be limited by characteristics of any particular initiating events or conditions.

The exemplary method 100 may, at step 120, comprise receiving communication acceptance (and/or rejection) profile information. The following discussion may generally refer to communication acceptance profile information. It should be noted that the phrase “communication acceptance profile information” is used herein to generally include information as to which communications should be accepted, which may of course include information as to which communications should be rejected (i.e., not accepted).

Step 120 may comprise receiving communication acceptance profile information from any of a variety of sources. For example and without limitation, step 120 may comprise receiving the communication acceptance profile information at a portable communication device that is implementing the method 100 from a user entering such information using a user interface device that is directly coupled to the portable communication device. Step 120 may, for example, comprise receiving the communication acceptance profile information at a network node that is implementing various aspects of the method 100. Such a network node may, for example, be currently servicing the portable communication device.

Also for example, step 120 may comprise receiving the communication acceptance profile information through a communication network. In an exemplary scenario, a user may originate communication acceptance profile information using a personal computer, and such information may then be downloaded into a portable communication device or a network node servicing a portable communication device. In such an exemplary scenario, a user may conveniently maintain communication acceptance profile information utilizing user-friendly personal computer user interface devices (e.g., full keyboard, full screen display, mouse, high speed interfaces, etc.) rather than user interface devices of the portable communication device, which may at times have limited user interface capability.

In general, step 120 may comprise receiving the communication acceptance profile information from any of a variety of sources. Accordingly, the scope of various aspects of the present invention should not be limited by characteristics of a particular communication source.

The communication acceptance profile information may, for example, comprise information related to one or more communication sources. For example, such information may comprise the identity of an originator of a message (e.g., a telephone number, IP address, e-mail address, sender name, etc.). Also for example, such information may comprise the identity of an intermediate communicator of a message (e.g., the identity of a corporate LAN, company, or an Internet Service Provider).

The communication acceptance profile information may, for example, comprise time information. Such time information may comprise time-of-day information, such as, for example, an indication of a specific time or a time window. Such time information may comprise information classifying particular time windows (e.g., as working time, commuting time, sleeping time, etc.). The time information may, for example, comprise day information. For example, such day information may comprise day-of-the-week information, date information or type-of-day information (e.g., workday, weekend, Sunday, holiday, etc.).

For example and without limitation, the communication acceptance profile information may comprise information correlating one or more communication sources to one or more communication timeframes. As a non-limiting example, the communication acceptance profile information may comprise information regarding accepting a call from a first or second communication source during business hours, accepting a call from the second communication source and a third communication source during non-business hours (including weekends and holidays), and accepting only calls from a fourth communication source during core sleeping hours.

The communication acceptance profile information may, for example, comprise information of one or more exceptions to a general communication acceptance profile. Such exception information may, for example, comprise information of communication source and timeframe. In an exemplary scenario, a user may specify that on a particular weekend, a communication from a source that would normally not be accepted may be accepted. Also, for example, a user may specify that a particular expected communication may be accepted during core sleeping hours for a particular night, where such a communication may typically be rejected.

Also for example, the communication acceptance profile information may comprise information of communication priority or urgency. Such information may, for example, comprise an indication that a message is an emergency message, high priority message, normal message, low priority message, etc.

Further for example, the communication acceptance profile information may comprise information of communication size. For example and without limitation, such a size may be expressed as the amount of information (e.g., in bytes, kilobytes or megabytes) contained in the pending message.

Additionally for example, the communication acceptance profile information may comprise information of how to process a pending communication that has been or is being received. For example and without limitation, the communication acceptance profile information may comprise information regarding whether and how a user of the portable communication device should be notified of a pending communication being received. In a non-limiting exemplary scenario, a communication acceptance profile may comprise information indicating that during sleep hours, only communications from a particular source may be received.

In general, the communication acceptance profile may comprise any of a variety of information types, including, for example and without limitation, communication source information and time information. Accordingly, the scope of various aspects of the present invention should not be limited by characteristics of particular communication source information, particular communication time information, or any particular information regarding communication acceptance and/or rejection.

The exemplary method 100 may, at step 130, comprise receiving information describing a pending communication. A pending communication may comprise any of a variety of information types. For example and without limitation, a pending communication may comprise a telephone call. Also for example, a pending communication may comprise an audio message, text message or video message. Further for example, a pending communication may comprise graphical information, still picture information or moving picture information. Accordingly, the scope of various aspects of the present invention should not be limited by characteristics of a particular pending communication.

The information describing a pending communication may, for example and without limitation, comprise information of a source of a pending communication. Such source information may, for example and without limitation, comprise the identity of an originator of a message (e.g., a telephone number, IP address, e-mail address, name, etc.). Also for example, such information may comprise the identity of an intermediate communicator of a message (e.g., the identity of a corporate LAN, company, or an Internet Service Provider).

The information describing a pending communication may, for example, comprise time information. Such time information may comprise time-of-day information, such as, an indication of a specific time or a time window. The time information may, for example, comprise day information. For example, such day information may comprise day-of-the-week information or date information.

Also for example, the information describing a pending communication may comprise information of communication priority or urgency. For example and without limitation, the information may comprise information classifying the urgency of the pending communication as an emergency message, a high priority message, a normal message, a low priority message, etc.

Further for example, the information describing a pending communication may comprise information of communication size. For example and without limitation, such a size may be expressed as the amount of information (e.g., in bytes, kilobytes or megabytes) contained in the pending message.

In general, the information describing a pending communication may comprise any of a variety of information types descriptive of a pending communication. Accordingly, the scope of various aspects of the present invention should not be limited by characteristics of particular types of information descriptive of a pending communication.

The information describing a pending communication may be received at any of a variety of apparatus in any of a variety of locations. For example and without limitation, step 130 may comprise receiving the information at the portable communication device. Also for example, step 130 may comprise receiving the information at a communication network node that is currently servicing the portable communication device. Further for example, step 130 may comprise receiving the information at a hub of a communication network, which is currently servicing the portable communication device. Accordingly, the scope of various aspects of the present invention should not be limited by characteristics of a particular receiving entity of the information describing a pending communication or of a particular location for such a receiving entity.

The exemplary method 100 may, at step 140, comprise analyzing the communication acceptance profile information and the information describing the pending communication to determine whether to accept (e.g., receive) the pending communication.

Step 140 may comprise performing such analysis in any of a variety of manners. For example and without limitation, step 140 may comprise analyzing identity information of a source of the pending communication and analyzing the communication acceptance profile information to determine whether the communication acceptance profile indicates that a communication from such a source should be accepted.

Also for example, step 140 may comprise analyzing time information (e.g., current time information, and timeframe or time window information). In an exemplary scenario step 140 may comprise analyzing time of the pending communication and time information in the communication acceptance profile to determine whether the communication acceptance profile indicates that a communication should be accepted at the time of the pending communication.

In another exemplary scenario, step 140 may comprise analyzing time and source information describing the pending communication, along with time and source information in the communication acceptance profile, to determine whether the communication acceptance profile indicates that a communication should be accepted from the particular source at the particular time.

Also for example, step 140 may comprise analyzing day (e.g., Sunday, Monday, etc.) and/or date information (e.g., December 25^{th}, July 4^{th}, January 1^{st}, etc.). In an exemplary scenario, step 140 may comprise analyzing day and/or date information to determine that utilizing a weekend or holiday profile for further analysis is appropriate. Continuing the exemplary scenario, the method may comprise analyzing time information, in light of the weekend/weekday distinction, to determine that communications (or particular types of communications) from the particular communication source may not be accepted at the present time on a weekend day. For example, such an exemplary communication may be accepted during typical workday hours on a workday, but not during evening hours on a weekend day or at any time on a holiday.

Similarly for example, step 140 may comprise analyzing message urgency information and message size information to determine whether the communication acceptance profile indicates that a pending communication should be accepted. In a non-limiting exemplary scenario, step 140 may comprise determining that a communication of a particular size may only be accepted if the communication is tagged as an emergency communication from a particular person.

The information describing a pending communication and information descriptive of a pending communication may be analyzed at any of a variety of apparatus in any of a variety of locations. For example and without limitation, step 140 may comprise analyzing the information at the portable communication device. Also for example, step 140 may comprise analyzing the information at a communication network node that is currently communicating with the portable communication device. Further for example, step 140 may comprise analyzing the information at a hub of a communication network, which is currently providing communication services to the portable communication device. Accordingly, the scope of various aspects of the present invention should not be limited by characteristics of a particular entity analyzing the information or of a particular location for such an entity.

In general, the exemplary method may comprise determining whether to accept the pending communication by analyzing the communication acceptance profile information and the information describing the pending communication. Accordingly, the scope of various aspects of the present invention should not be limited by characteristics of a particular type of analysis or particular type of information being analyzed.

The exemplary method 100 may, at step 150, comprise controlling execution flow of the exemplary method 100. Exemplary step 150 may, if step 140 determines that a pending communication should not be accepted, direct execution flow back up to step 120 or step 130. Exemplary step 150 may, if step 140 determines that a pending communication should be accepted, direct execution flow to step 160 for receiving the pending communication. It should be noted that exemplary step 150 illustrates exemplary method flow control and should by no means limit the scope of various aspects of the present invention to characteristics of a particular execution flow.

The exemplary method 100 may, at step 160, comprise receiving the pending communication (e.g., at the portable communication device). As mentioned previously, such a pending communication may comprise any of a variety of communication and information characteristics. For example and without limitation, step 160 may comprise receiving a telephone call, telephone message, textual message, audio message, video message, etc.

Following step 160, execution of the exemplary method 100 may, for example, flow back up to steps 120 or 130. Alternatively, for example, the execution may flow to additional processing activities related to the received communication.

The exemplary method 100 illustrated in FIG. 1 and discussed previously was presented to provide specific examples of a portion of generally broader aspects of the present invention. Accordingly, by no means should the scope of various aspects of the present invention be limited by specific characteristics of the exemplary method 100.

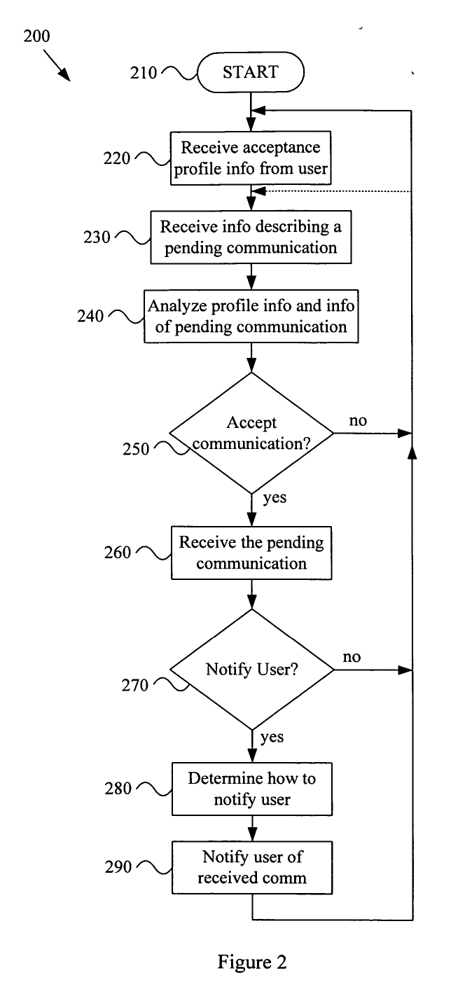

FIG. 2 illustrates an exemplary method 200 for automatically controlling operation of a portable communication device based on a communication acceptance/rejection profile, in accordance with various aspects of the present invention. The exemplary method 200 may, for example and without limitation, share various characteristics with the exemplary method 100 illustrated in FIG. 1 and discussed previously.

For example and without limitation, exemplary steps 210, 220, 230, 240, 250 and 260 of the exemplary method 200 may share various characteristics with exemplary steps 110, 120, 130, 140, 150 and 160, respectively, of the method 100 illustrated in FIG. 1 and discussed previously. Additionally, the exemplary method 200 illustrated in FIG. 2 may comprise aspects additional to the aspects of the exemplary method 100 illustrated in FIG. 1, some of which are discussed below.

For example, after determining to accept a pending communication, the exemplary method 200 may, at step 270, comprise analyzing the communication acceptance profile information and the information describing the pending communication to determine whether to notify the user. As explained previously, the communication acceptance profile information may comprise information that indicates whether a user should be notified about an incoming or received communication. Such information may be global (i.e., applying to all communications) or specific to particular communications.

In a non-limiting exemplary scenario, the communication acceptance profile may comprise information indicating that a user is not to be notified if a communication arrives during sleeping hours unless the arriving communication is tagged as an emergency communication. In another exemplary scenario, the communication acceptance profile may comprise information indicating that a user is generally not to be notified on the weekend of an incoming voice message, but the user is to be notified of incoming telephone calls and incoming voice messages from a particular source.

Step 270 may control execution flow of the exemplary method 200 in accordance with the notification determination results. For example, if step 270 determines that a user should not be notified of an incoming communication, step 270 may direct execution flow of the method 200 back up to steps 220 or 230. Also for example, if step 270 determines that a user should be notified of an incoming communication, step 270 may direct execution flow of the method 200 to step 280 for further notification processing.

The exemplary method 200 may, at step 280, comprise analyzing the communication acceptance profile information and the information describing the pending communication to determine how to notify the user. As explained previously, the communication acceptance profile information may comprise information that indicates how a user should be notified about an incoming or received communication. Such information may be global (i.e., applying to all communications) or specific to particular communications.

In a non-limiting exemplary scenario, the communication acceptance profile may comprise information indicating that a user should be notified of a communication arriving during a commuting time window by the portable communication device vibrating and ringing. In another exemplary scenario, the communication acceptance profile may comprise information indicating that a user should be notified of an emergency communication arriving during sleeping hours by a loud audio alarm sounding until the user interacts with the portable communication device. In an additional exemplary scenario, the communication acceptance profile may comprise information indicating that a user should be notified by vibration during Monday and Wednesday 8:00-9:00 am meetings. Note that the communication acceptance profile may also comprise information of a default notification style to utilize in the absence of more specific notification information.

In general, steps 270 and 280 may comprise analyzing the communication acceptance profile information and the information describing the pending communication to determine whether and/or how to notify the user. Accordingly, the scope of various aspects of the present invention should not be limited by characteristics of a particular manner in which such a determination may be made.

The exemplary method 200 may, at step 290, comprise notifying the user in accordance with the notification characteristics determined at step 280. Such a notification may comprise any of a variety of notification characteristics. For example and without limitation, such a notification may be physical (e.g., vibratory), audible (e.g., a ring or ring style) or visible (e.g., a blinking light or display, a display message, or a display icon). Accordingly, the scope of various aspects of the present invention should not be limited by characteristics of a particular notification.

Following step 290, the execution of the exemplary method 200 may, for example, flow back up to steps 220 or 230. Alternatively, for example, the execution may flow to additional processing activities related to the received communication.

The exemplary method 200 illustrated in FIG. 2 and discussed previously was presented to provide specific examples of a portion of generally broader aspects of the present invention. Accordingly, by no means should the scope of various aspects of the present invention be limited by specific characteristics of the exemplary method 200.

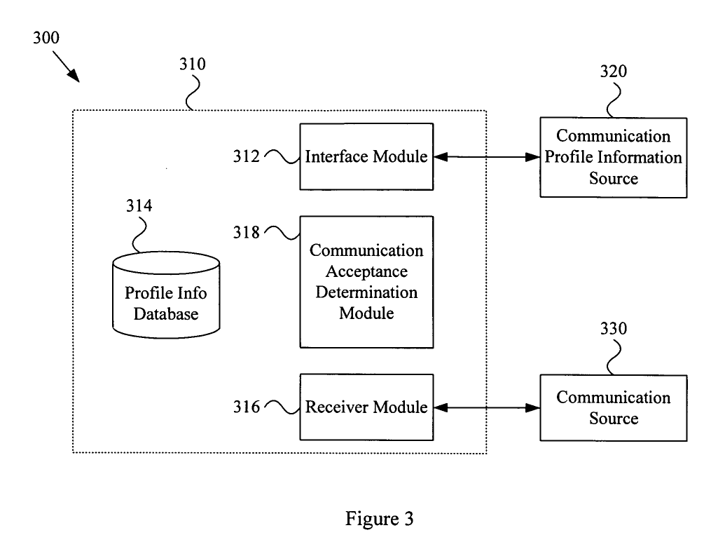

FIG. 3 shows a block diagram of an exemplary communication system 300 implementing automatic control of portable communication device operation based on a communication acceptance/rejection profile, in accordance with various aspects of the present invention. The exemplary system 300 may comprise a portable communication device 310. Various components and subsystems of the portable communication device 310 may, for example and without limitation, perform various aspects of the exemplary methods 100, 200 illustrated in FIGS. 1-2 and discussed previously.

As mentioned previously, the portable communication device 310 may comprise characteristics of any of a variety of portable communication devices. For example and without limitation, the portable communication device may comprise a cellular phone. Also for example, the portable communication device may comprise a portable computer, electronic email device, pager, etc. Accordingly, the scope of various aspects of the present invention should not be limited by characteristics of a particular type of portable communication device.

The exemplary portable communication device 310 may comprise an interface module 312 that receives communication acceptance profile information from a communication profile information source 320. The interface module 312 may, for example and without limitation, perform various aspects of the functionality of steps 120 and 220 of the exemplary methods 100, 200 illustrated in FIGS. 1-2 and discussed previously.

The communication profile information source 320 may comprise any of a variety of information sources. For example and without limitation, the communication profile information source 320 may comprise a user entering such information with a user interface device. Also for example, the communication profile information source 320 may comprise a user or computer sending communication acceptance profile information through a communication network. In an exemplary scenario, a user may originate communication acceptance profile information using a networked personal computer, and such information may then be downloaded into the portable communication device 310 through the interface module 312 and a communicative coupling between the interface module 312 and the personal computer.

As explained previously with regard to the exemplary method 100 illustrated in FIG. 1, the communication acceptance profile information may comprise any of a variety of types of communication information. For example and without limitation, the communication acceptance profile information may comprise information related to the identity of one or more communication sources (e.g., a telephone number, IP address, e-mail address, sender name, identity of a corporate LAN, identity of an Internet Service Provider, etc.).

The communication acceptance profile information may, for example, comprise time information (e.g., time-of-day, time window, day, day-of-the-week, date, type-of-day, etc.). For example, the communication acceptance profile information may comprise information correlating one or more communication sources to one or more communication timeframes. Also for example, the communication acceptance profile information may comprise information of one or more exceptions to a general communication acceptance profile. Additionally for example, the communication acceptance profile information may comprise information of communication priority or urgency. Further for example, the communication acceptance profile information may comprise information of communication size.

Still further for example, the communication acceptance profile information may comprise information of how to process a pending communication that has been or is being received. For example and without limitation, the communication acceptance profile information may comprise information regarding whether and how a user of the portable communication should be notified of a pending communication being received.

In general, the interface module 312 may receive communication acceptance profile information from a communication profile information source 320. Accordingly, the scope of various aspects of the present invention should not be limited by characteristics of particular communication source information, sources of such information, or manner and apparatus for receiving such information.

The exemplary portable communication device 310 may comprise a profile information database 314 that stores communication acceptance profile information. For example and without limitation, the interface module 312 may store received communication acceptance profile information in the profile information database 314. The profile information database may comprise characteristics of any of a variety of data storage devices, including but not limited to, memory chips (volatile and non-volatile), hard drives, memory disks and diskettes, etc. Accordingly, the scope of various aspects of the present invention should not be limited by characteristics of any particular data memory device.

The exemplary portable communication device 310 may comprise a receiver module 316 that receives information describing a pending communication. The receiver module 316 may, for example and without limitation, perform various aspects of the functionality of steps 130 and 230 of the exemplary methods 100, 200 illustrated in FIGS. 1-2 and discussed previously.

The receiver module 316 may, for example, receive information describing a pending communication from a communication source 330. The communication source 330 may comprise any of a variety of communication sources. For example and without limitation, the communication source 330 may comprise a portable phone call originator, message originator, an Internet Service Provider, a company, etc. For example, the communication source 330 may comprise a personal computer of an originator, a portable or cellular phone of an originator, an Internet gateway, a portable communication device of an originator, a company LAN, etc. Accordingly, the scope of various aspects of the present invention should not be limited by characteristics of a particular communication source.

As mentioned previously, a pending communication may comprise any of a variety of information types. For example and without limitation, a pending communication may comprise a telephone call. Also for example, a pending communication may comprise an audio message, text message or video message. Further for example, a pending communication may comprise data information, graphical information, still picture information or moving picture information. Accordingly, the scope of various aspects of the present invention should not be limited by characteristics of a particular pending communication.

Also as mentioned previously, the information describing a pending communication may comprise information of any of a variety of communication traits. For example and without limitation, information describing a pending communication may comprise information of a source of a pending communication. The information describing a pending communication may, for example, comprise time information. Also for example, the information describing a pending communication may comprise information of communication priority or urgency. Further for example, the information describing a pending communication may comprise information of communication size. Accordingly, the scope of various aspects of the present invention should not be limited by characteristics of particular types of information related to a pending communication.

The exemplary portable communication device 310 may comprise a communication acceptance determination module 318 that determines whether to accept the pending communication by analyzing the communication acceptance profile information and the information describing the pending communication. The communication acceptance determination module 318 may, for example and without limitation, perform various aspects of the functionality of steps 140-150 of the exemplary method 100 illustrated in FIG. 1 and steps 240-250 of the exemplary method 200 illustrated in FIG. 2 and discussed previously.

The communication acceptance determination module 318 may determine whether to accept the pending communication in any of a variety of manners. For example and without limitation, the communication acceptance determination module 318 may analyze identity information of a source of the pending communication and analyze the communication acceptance profile information (e.g., as may be stored in the profile information database 314) to determine whether the communication acceptance profile indicates that a communication from such a source should be accepted.

Also for example, the communication acceptance determination module 318 may analyze time information (e.g., current time information, and timeframe or time window information). In an exemplary scenario, the communication acceptance determination module 318 may analyze time of the pending communication and time information in the communication acceptance profile (e.g., as may be stored in the profile information database 314) to determine whether the communication acceptance profile indicates that a communication should be accepted at the time of the pending communication.

In another exemplary scenario, the communication acceptance determination module 318 may analyze time and source information describing the pending communication, along with time and source information in the communication acceptance profile, to determine whether the communication acceptance profile indicates that a communication should be accepted from the particular source at the particular time.

The communication acceptance determination module 318 may, for example, analyze day (e.g., Sunday, Monday, etc.) and/or date (e.g., December 25^{th}, July 4^{th}, January 1^{st}, etc.) information. In an exemplary scenario, the communication acceptance determination module 318 may analyze day and/or date information to determine that utilizing a weekend or holiday profile for further analysis is appropriate. Continuing the exemplary scenario, the communication acceptance determination module 318 may analyze time information, in light of the weekend/weekday distinction, to determine that communications (or particular types of communications) from the particular communication source may not be accepted at the present time on a weekend day. For example, the communication acceptance determination module 318 may accept such exemplary communication during typical workday hours on a workday, but not during evening hours on a weekend day or at any time on a holiday.

Similarly for example, the communication acceptance determination module 318 may analyze message urgency information and message size information to determine whether the communication acceptance profile indicates that a pending communication should be accepted. In a non-limiting exemplary scenario, the communication acceptance determination module 318 may determine that a communication of a particular size may only be accepted if the communication is tagged as an emergency communication from a particular person.

In general, the communication acceptance determination module 318 may determine whether to accept the pending communication by analyzing the communication acceptance profile information and the information describing the pending communication. Accordingly, the scope of various aspects of the present invention should not be limited by characteristics of a particular type of analysis, particular types of information being analyzed, or particular type of apparatus for performing such analysis.

As mentioned previously, the receiver module 316 may receive information describing a pending communication. The receiver module 316 may, for example and without limitation, perform functionality of steps 160 and 260 of the exemplary methods 100, 200 illustrated in FIGS. 1-2 and discussed previously.

In an exemplary scenario where the communication acceptance determination module 318 determines that a particular pending communication should be accepted, the receiver module 316 (or other receiver module) may receive the pending communication. In another exemplary scenario where the communication acceptance determination module 318 determines that a particular communication is not to be received, then the communication acceptance determination module 318 may direct the receiver module 316 not to receive such a communication.

As mentioned previously, such a pending communication may comprise any of a variety of communication and information characteristics. For example and without limitation, the receiver module 316 may comprise receiving a telephone call, telephone message, textual message, audio message, video message, etc.

Referring again to the communication acceptance determination module 318, after determining to accept a pending communication, the communication acceptance determination module 318 may analyze the communication acceptance profile information and the information describing the pending communication to determine whether to notify the user. For example and without limitation, the communication acceptance determination module 318 may perform aspects of the functionality of step 270 of the exemplary method 200 illustrated in FIG. 2 and discussed previously.

Note that determining whether to notify the user and determining whether to accept a pending communication may comprise analyzing different criteria. For example, a communication acceptance profile may indicate that a communication from a particular source may be accepted during core sleeping hours or during a business meeting, but that the user is not to be notified. The user may then, for example, check for such received communications at a convenient time.

In general, the communication acceptance determination module 318 may analyze the communication acceptance profile information and the information describing the pending communication to determine whether to notify the user of the pending communication. Accordingly, the scope of various aspects of the present invention should not be limited by characteristics of a particular manner of determining whether to notify a user.

The exemplary communication acceptance determination module 318 may analyze the communication acceptance profile information and the information describing the pending communication to determine how to notify the user. For example and without limitation, the communication acceptance determination module 318 may perform various aspects of the functionality of step 280 of the exemplary method 200 illustrated in FIG. 2 and discussed previously.

As explained previously, the communication acceptance profile information may comprise information that indicates how a user should be notified about an incoming or received communication. Such information may be global (i.e., applying to all communications) or specific to particular communications.

In a non-limiting exemplary scenario, the communication acceptance profile may comprise information indicating that the portable communication device 310 should notify a user of a communication arriving during a commuting time window by the portable communication device vibrating and ringing. The communication acceptance determination module may direct a user interface module to perform such a notification. In another exemplary scenario, the communication acceptance profile may comprise information indicating that the portable communication device 310 should notify a user of an emergency communication arriving during sleeping hours by a loud audio alarm sounding until the user interacts with the portable communication device 310. In an additional exemplary scenario, the communication acceptance profile may comprise information indicating that the portable communication device 310 should notify a user by vibration during Monday and Wednesday 8:00-9:00 am meetings. Note that the communication acceptance profile may also comprise information of a default notification style to utilize in the absence of more specific notification information.

In general, the communication acceptance determination module 318 may analyze the communication acceptance profile information and the information describing the pending communication to determine whether and/or how to notify the user. Accordingly, the scope of various aspects of the present invention should not be limited by characteristics of a particular manner in which such a determination may be made, apparatus for making such a determination, manner of notifying the user, or apparatus for notifying the user.

The exemplary system 300 illustrated in FIG. 3 and discussed previously was presented to provide specific examples of a portion of generally broader aspects of the present invention. Accordingly, by no means should the scope of various aspects of the present invention be limited by specific characteristics of the exemplary system 300.

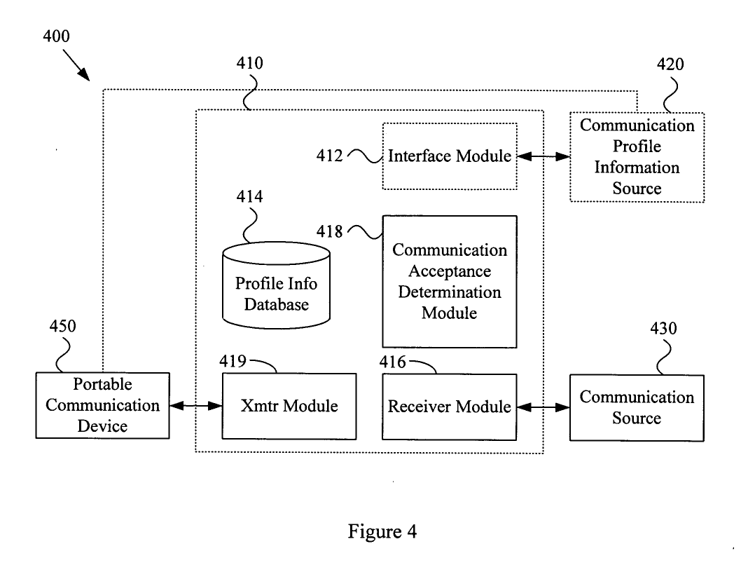

FIG. 4 shows a block diagram of an exemplary communication system 400 implementing automatic control of portable communication device operation based on a communication acceptance/rejection profile, in accordance with various aspects of the present invention. The exemplary system 400 may, for example and without limitation, share various characteristics with the exemplary system 300 illustrated in FIG. 3 and discussed previously. Also for example and without limitation, the exemplary system 400 may perform various aspects of the functionality of the exemplary methods 100, 200 illustrated in FIGS. 1-2 and discussed previously.

The exemplary communication system 400 may comprise a portable communication device 450. As mentioned previously, the portable communication device 450 may comprise characteristics of any of a variety of portable communication devices. For example and without limitation, the portable communication device 450 may comprise a cellular phone. Also for example, the portable communication device 450 may comprise a portable computer, electronic email device, pager, etc. Accordingly, the scope of various aspects of the present invention should not be limited by characteristics of a particular type of portable communication device.

The exemplary system 400 may comprise a communication profile information source 420 and a communication source 430. For example and without limitation, the communication profile information source 420 may share various characteristics with the communication profile information source 320 of the exemplary system 300 illustrated in FIG. 3 and discussed previously. Similarly, for example and without limitation, the communication source 430 may share various characteristics with the communication source 330 of the exemplary system 300 illustrated in FIG. 3 and discussed previously.

The exemplary communication system 400 may comprise an intermediate communication node 410. The intermediate communication node 410 may, for example and without limitation, share various characteristics with the exemplary portable communication device 310 illustrated in FIG. 3 and discussed previously.

For example, the intermediate communication node 410 may comprise an interface module 412 that shares various characteristics with the interface module 312 of the exemplary system 300 illustrated in FIG. 3. Also for example, the intermediate communication node 410 may comprise a profile information database 414 that shares various characteristics with the profile information database 314 of the exemplary system 300 illustrated in FIG. 3. Further for example, the intermediate communication node 410 may comprise a receiver module 416 that shares various characteristics with the receiver module 316 of the exemplary system 300 illustrated in FIG. 3. Still further for example, the intermediate communication node 410 may comprise a communication acceptance determination module 418 that shares various characteristics with the communication acceptance determination module 318 of the exemplary system 300 illustrated in FIG. 3.

The intermediate communication node 410 may also comprise a transmitter module 419 that communicates information of an accepted communication to the portable communication device 450. The transmitter module 419 may, for example, comprise a transmitter portion of a transceiver module or may, for example, comprise a transmitter for one-way communications.

Comparing the exemplary systems 300 and 400, rather than locating various communication control modules at the portable communication device 310, as shown in the exemplary system 300 of FIG. 3, the exemplary system 400 of FIG. 4 places various communication control modules at the intermediate communication node 410.

In an exemplary scenario, a user may utilize the portable communication device 450, or some other user interface mechanism (e.g., a personal computer system), to communicate communication acceptance profile information to the interface module 412 of the intermediate communication node 410. The interface module 412 (e.g., autonomously or working with the communication acceptance determination module 418) may store the communication acceptance profile information in the profile information database 414 of the intermediate communication node 410.

The receiver module 416 of the intermediate communication node 410 may, for example, receive information of a pending communication (e.g., a communication ultimately destined for the portable communication device 450) from the communication source 430. The communication acceptance determination module 418 of the intermediate communication node 410 may then determine whether to accept the pending communication for the portable communication device 450 by analyzing the communication acceptance profile information and the information describing the pending communication.

In an exemplary scenario, the receiver module 416 may accept all communications addressed to the portable communication device 450, and then the communication acceptance determination module 418 may perform the analysis to determine whether to further transmit the communications to the portable communication device 450. In an alternative exemplary scenario, the communication acceptance determination module 418 may perform the analysis prior to the receiver module 416 receiving each entire communications, so that the intermediate communication node 410 does not spend resources receiving messages that are not going to be further communicated.

The exemplary system 400 illustrated in FIG. 4 and discussed previously was presented to provide specific examples of a portion of generally broader aspects of the present invention. Accordingly, by no means should the scope of various aspects of the present invention be limited by specific characteristics of the exemplary system 400. For example, the exemplary system 400 presented an alternative placement for various functional modules of the exemplary system 300 illustrated in FIG. 3. The scope of various aspects of the present invention should not be limited by specific placements of the various functional modules.

It should be noted that the methods and systems illustrated in FIGS. 1-4 and discussed previously are merely exemplary, and accordingly, the scope of various aspects of the present invention should not be limited by characteristics of the exemplary methods and systems.

It should also be noted that various modules discussed previously may be implemented in hardware, software or a combination thereof. Also, various modules may share portions or sub-modules with other modules. For example, a first functional module may share a substantial amount of software and/or hardware with a second functional module. Accordingly, the scope of various aspects of the present invention should not be limited by any arbitrary notion of hardware or software boundaries between two functional modules.

It should further be noted that various components or modules discussed previously may be local or distributed. For example, various components or modules discussed previously may be integrated on a single integrated circuit or may be implemented using a plurality of discrete circuit components. Also for example, various components or modules may be geographically collocated or distributed through a communication network. Accordingly, the scope of various aspects of the present invention should not be limited by characteristics of any particular implementation, including physical and/or geographical characteristics.

In summary, various aspects of the present invention provide a system and method for automatically controlling operation of a portable communication device based on a communication acceptance/rejection profile. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for automatically controlling operation of a portable communication device, the method comprising:
receiving communication acceptance profile information;
receiving information describing a pending communication;
determining whether to accept the pending communication by analyzing at least a portion of the communication acceptance profile information and the information describing the pending communication; and
receiving the pending communication, if it is determined that the pending communication is to be accepted.

2. The method of claim 1, wherein the communication acceptance profile information comprises information of communication source.

3. The method of claim 1, wherein the communication acceptance profile information comprises information of time.

4. The method of claim 1, wherein the communication acceptance profile information comprises information correlating a communication source to a communication timeframe.

5. The method of claim 1, wherein receiving information describing a pending communication comprises receiving information describing a pending communication at the portable communication device.

6. The method of claim 1, wherein receiving information describing a pending communication comprises receiving information describing a pending communication at a communication network node other than the portable communication device.

7. The method of claim 1, wherein determining whether to accept the pending communication comprises analyzing time information.

8. The method of claim 1, wherein determining whether to accept the pending communication comprises analyzing day information.

9. The method of claim 1, wherein the pending communication comprises a telephone call.

10. The method of claim 1, wherein the pending communication comprises audio information.

11. The method of claim 1, wherein the pending communication comprises text information.

12. The method of claim 1, further comprising analyzing at least a portion of the communication acceptance profile information and the information describing the pending communication to determine how to notify the user.

13. The method of claim 1, wherein the communication acceptance profile information comprises information of an exception to a general communication acceptance profile.

14. A system for controlling operation of a portable communication device, the system comprising:
a first module that receives communication acceptance profile information;
a second module that receives information describing a pending communication; and
a third module that determines whether to accept the pending communication by analyzing at least a portion of the communication acceptance profile information and the information describing the pending communication;
wherein the second module receives the pending communication if the third module determines that the pending communication is to be accepted.

15. The system of claim 1, wherein:
the first module comprises an interface module;
the second module comprises a receiver module; and
the third module comprises a communication acceptance determination module.

16. The system of claim 14, wherein the communication acceptance profile information comprises information of communication source.

17. The system of claim 14, wherein the communication acceptance profile information comprises information of time.

18. The system of claim 14, wherein the communication acceptance profile information comprises information correlating a communication source to a communication timeframe.

19. The system of claim 14, wherein the second module resides on the portable communication device.

20. The system of claim 14, wherein the second module resides on a communication network node other than the portable communication device.

21. The system of claim 14, wherein the third module determines whether to accept the pending communication by analyzing time information.

22. The system of claim 14, wherein the third module determines whether to accept the pending communication by analyzing day information.

23. The system of claim 14, wherein the pending communication comprises a telephone call.

24. The system of claim 14, wherein the pending communication comprises audio information.

25. The system of claim 14, wherein the pending communication comprises text information.

26. The system of claim 14, wherein the third module analyzes at least a portion of the communication acceptance profile information and the information describing the pending communication to determine how to notify the user.

27. The system of claim 14, wherein the communication acceptance profile information comprises information of an exception to a general communication acceptance profile.
